(19) United States
(12) Patent Application Publication
(10) Pub. No.: US 2013/0070656 A1
(43) Pub. Date: Mar. 21, 2013

(54) Method and Apparatus for the Multimode Terminal in Idle Mode Operation in CDMA 1XRTT and Frame Asynchronous TD-SCDMA Networks

(71) Applicants: Tom Chin, San Diego, CA (US); Guangming Shi, San Diego, CA (US); Kuo-Chun Lee, San Diego, CA (US)

(72) Inventors: Tom Chin, San Diego, CA (US); Guangming Shi, San Diego, CA (US); Kuo-Chun Lee, San Diego, CA (US)

(21) Appl. No.: 13/384,173

(22) PCT Filed: Apr. 2, 2010
(86) PCT No.: PCT/US10/29842

§ 371 Date: Jan. 13, 2012

Related U.S. Application Data
(60) Provisional application No. 61/257,682, filed on Nov. 3, 2009.

(51) Int. Cl. H04W 52/02; H04W 68/00; H04W 88/06

(52) U.S. Cl. 370/311

(57) ABSTRACT

Method and apparatus for the multimode terminal (MMT) in idle mode operation in CDMA 1xRTT and frame asynchronous TD-SCDMA networks techniques for scheduling paging intervals in the multimode terminal to reduce paging interval conflicts. The method generally includes determining a circuit-switched (CS) discontinuous reception (DRX) cycle length of the first network (1010), determining a paging cycle length of the second network (1020), setting a packet-switched (PS) DRX cycle length” based on the paging cycle length and the CS DRX cycle length to avoid overlap between a paging interval of the first network and a paging interval of the second network (1030), and communicating the PS DRX cycle length to the first network (1040).

### CROSS-REFERENCE TO RELATED APPLICATION(S)

This application claims the benefit of U.S. Provisional Patent Application No. 61/257,682, entitled “METHOD AND APPARATUS FOR THE MULTIMODE TERMINAL IN IDLE MODE OPERATION IN CDMA 1XRTT AND FRAME ASYNCHRONOUS TD-SCDMA NETWORKS,” filed on Nov. 3, 2009, which is expressly incorporated by reference herein in its entirety.

### BACKGROUND

1. Field

Certain aspects of the present disclosure generally relate to wireless communications and, more particularly, to scheduling paging intervals in a multimode terminal (MMT) capable of communicating via at least two different radio access technologies (RATs) in an effort to reduce paging interval conflicts.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but also to advance and enhance the user experience with mobile communications.

### SUMMARY

In an aspect of the disclosure, a method for communicating, by a multimode terminal (MMT), with first and second networks via first and second radio access technologies (RATs) is provided. The method generally includes determining a circuit-switched (CS) discontinuous reception (DRX) cycle length of the first network, determining a paging cycle length of the second network, setting a packet-switched (PS) DRX cycle length based on the paging cycle length and the CS DRX cycle length to avoid overlap between a paging interval of the first network and a paging interval of the second network, and communicating the PS DRX cycle length to the first network.

In an aspect of the disclosure, an apparatus for communicating with first and second networks via first and second RATs is provided. The apparatus generally includes means for determining a CS DRX cycle length of the first network, means for determining a paging cycle length of the second network, means for setting a PS DRX cycle length based on the paging cycle length and the CS DRX cycle length to avoid overlap between a paging interval of the first network and a paging interval of the second network, and means for communicating the PS DRX cycle length to the first network.

In an aspect of the disclosure, an apparatus for communicating with first and second networks via first and second RATs is provided. The apparatus generally includes at least one processor and a memory coupled to the at least one processor. The at least one processor is typically configured to determine a CS DRX cycle length of the first network, to determine a paging cycle length of the second network, to set a PS DRX cycle length based on the paging cycle length and the CS DRX cycle length to avoid overlap between a paging interval of the first network and a paging interval of the second network, and to communicate the PS DRX cycle length to the first network.

In an aspect of the disclosure, a computer-program product for communicating with first and second networks via first and second RATs is provided. The computer-program product typically includes a computer-readable medium having code for determining a CS DRX cycle length of the first network, determining a paging cycle length of the second network, setting a PS DRX cycle length based on the paging cycle length and the CS DRX cycle length to avoid overlap between a paging interval of the first network and a paging interval of the second network, and communicating the PS DRX cycle length to the first network.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 is a block diagram conceptually illustrating an example of a telecommunications system in accordance with certain aspects of the present disclosure.

FIG. 2 is a block diagram conceptually illustrating an example of a frame structure in a telecommunications system in accordance with certain aspects of the present disclosure.

FIG. 3 is a block diagram conceptually illustrating an example of a Node B in communication with a user equipment device (UE) in a telecommunications system in accordance with certain aspects of the present disclosure.

FIG. 4 illustrates an example time division synchronous code division multiple access (TD-SCDMA) network overlaid on an example code division multiple access (CDMA) 1xRTT (Radio Transmission Technology) network in accordance with certain aspects of the present disclosure.

FIG. 5 illustrates an example paging interval conflict between a TD-SCDMA network and a CDMA 1x network in accordance with certain aspects of the present disclosure.

FIG. 6 illustrates the operation of the CDMA 1x paging cycle, in accordance with certain aspects of the present disclosure.

FIG. 7 illustrates a Discontinuous Reception (DRX) cycle for TD-SCDMA with the Paging Block Periodicity (PBP) and the structure of a TD-SCDMA Paging Interval Channel (PICH) and a Paging Channel (PCH), in accordance with certain aspects of the present disclosure.

FIGS. 8A and 8B illustrate a conflict between a CDMA 1x Quick Paging Channel (QPCH) monitoring interval and a TD-SCDMA PICH monitoring frame when the QPCH interval trails the PICH frame, in accordance with certain aspects of the present disclosure.

FIGS. 9A and 9B illustrate a conflict between a CDMA 1x Quick Paging Channel (QPCH) monitoring interval and a TD-SCDMA PICH monitoring frame when the QPCH interval leads the PICH frame, in accordance with certain aspects of the present disclosure.

FIG. 10 is a functional block diagram conceptually illustrating example blocks executed to schedule paging intervals for a multimode terminal (MMT) in an effort to reduce paging interval conflicts between paging intervals of two networks communicating via two different radio access technologies (RATs) in accordance with certain aspects of the present disclosure.

FIG. 11 illustrates the undesired case of the TD-SCDMA DRX cycle length equaling the CDMA 1x paging cycle, such that QPCH interval and the PICH frame always conflict, in accordance with certain aspects of the present disclosure.

FIG. 12 illustrates the case where if there is a paging interval conflict, the next TD-SCDMA PICH frame does not conflict with the CDMA 1x QPCH interval by choosing a smaller TD-SCDMA DRX cycle length, in accordance with certain aspects of the present disclosure.

FIG. 13 illustrates the case where if there is a paging interval conflict, the next CDMA 1x QPCH interval does not conflict with the TD-SCDMA PICH frame by choosing a larger TD-SCDMA DRX cycle length, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### An Example Telecommunications System

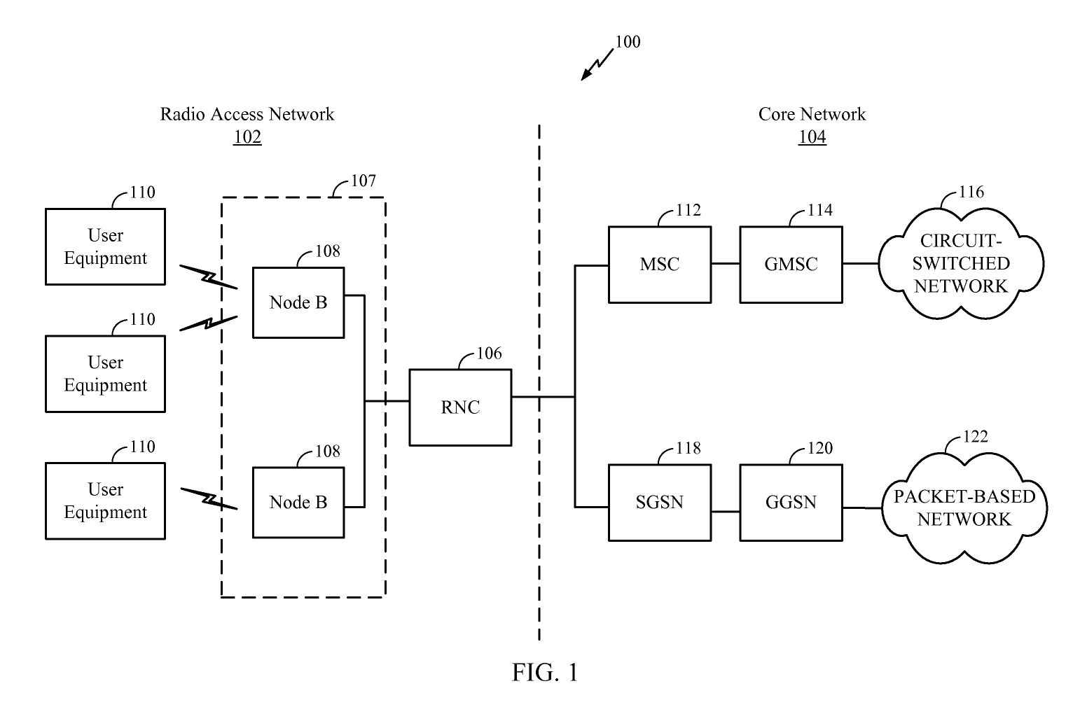

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

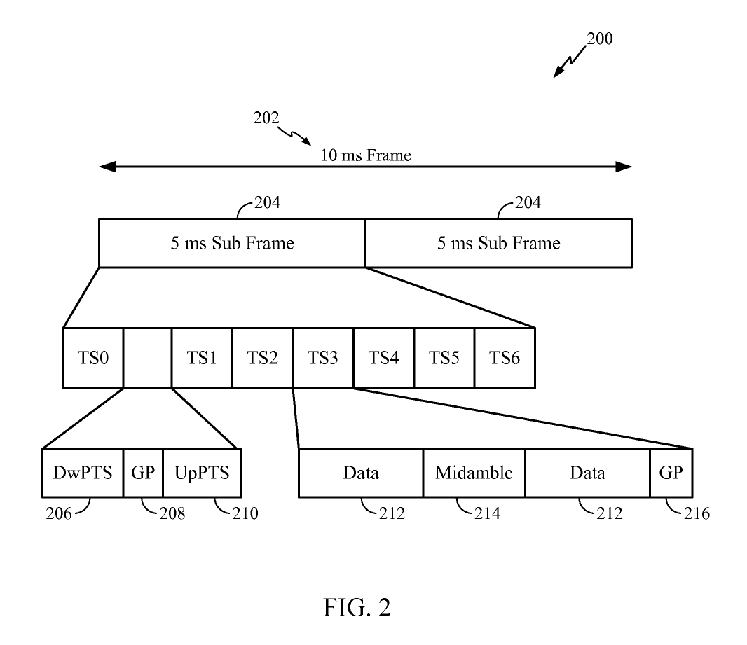

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second timeslot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

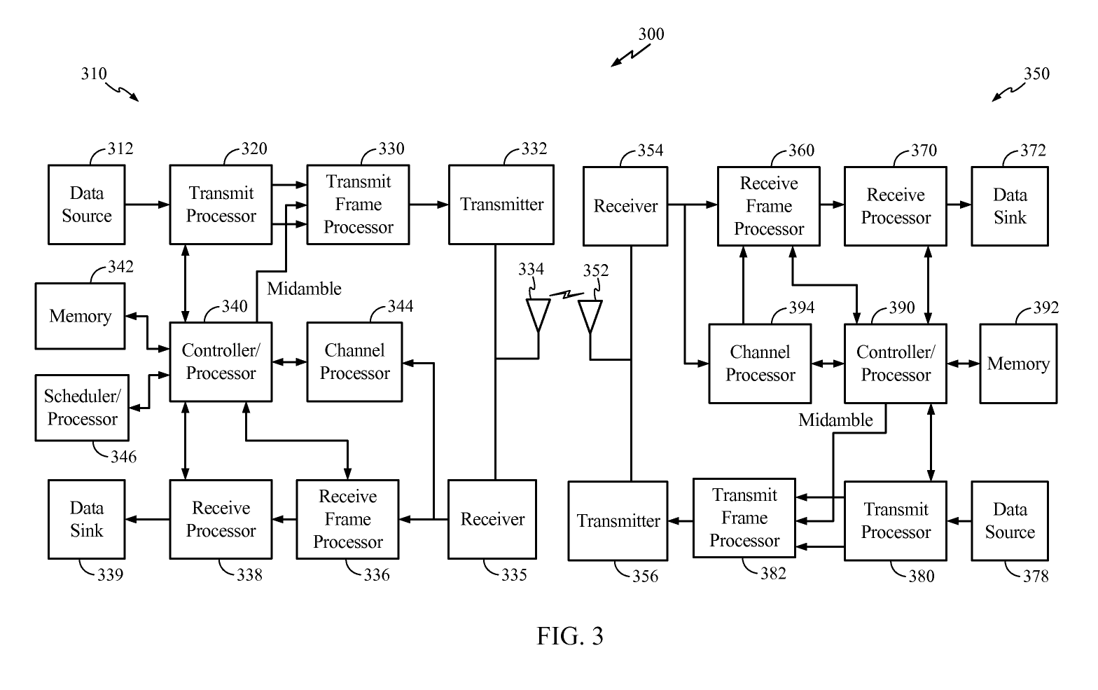

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### An Example Method for the Multimode Terminal in Idle Mode Operation in Cdma 1XRTT and Frame Asynchronous TD-SCDMA Networks

In order to expand the services available to subscribers, some MSs support communications with multiple radio access technologies (RATs). For example, a multimode terminal (MMT) may support TD-SCDMA and CDMA 1xRTT (Radio Transmission Technology) for voice and broadband data services.

As a result of supporting multiple RATs, there may be instances in which an MMT may be in an idle mode in both the TD-SCDMA and the CDMA 1xRTT networks. This may typically entail the MMT listening for traffic indication or paging messages in both networks. Unfortunately, an MMT with a single RF chain may only listen to one network at a time.

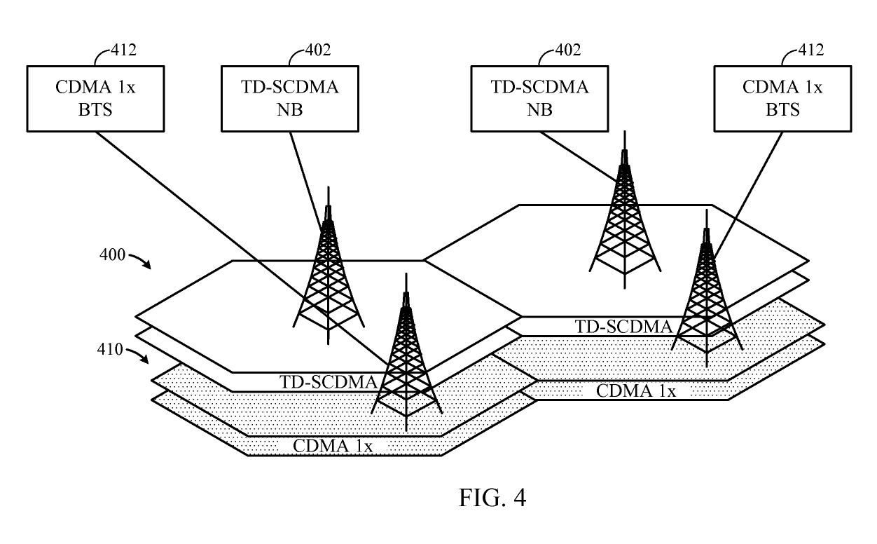

In deployment of the TD-SCDMA service, the TD-SCDMA network may become a radio access network overlaid with other technologies, such as CDMA 1xRTT. A multimode terminal (e.g., TD-SCDMA and CDMA 1x) may register with both networks to provide services. FIG. 4 illustrates an example TD-SCDMA network 400 overlaid on an example CDMA 1xRTT network 410. An MMT may communicate with either or both networks 400, 410 via TD-SCDMA node Bs (NBs) 402 and/or CDMA 1x base transceiver stations (BTSs) 412.

For example, one use case may involve the MMT registering with the CDMA 1x network for voice call service and with the TD-SCDMA network for data service (e.g. TD-SCDMA HSDPA service). Another use case may occur when the MMT has two SIMs: one for CDMA and another for TD-SCDMA.

The MMT—called user equipment (UE) in TD-SCDMA or a mobile station (MS) in CDMA 1x—may register with both networks in order to receive a paging message for reception of a mobile-terminated call in idle mode. However, this may call for the multimode terminal to periodically switch between the CDMA network and the TD-SCDMA network to check for the paging message in both networks. This especially becomes an issue if the MMT can only transmit or receive with a single radio access technology at any one time.

If the MMT can only listen to one network at a time, when paging intervals for two networks such as TD-SCDMA and CDMA 1x (or EVDO, WCDMA) overlap, this creates a paging interval conflict, and the MMT can only choose one network from which to listen to the paging messages. This can be due to having only a single RF chain or to limited processing power of the MMT. This is also called a hybrid configuration.

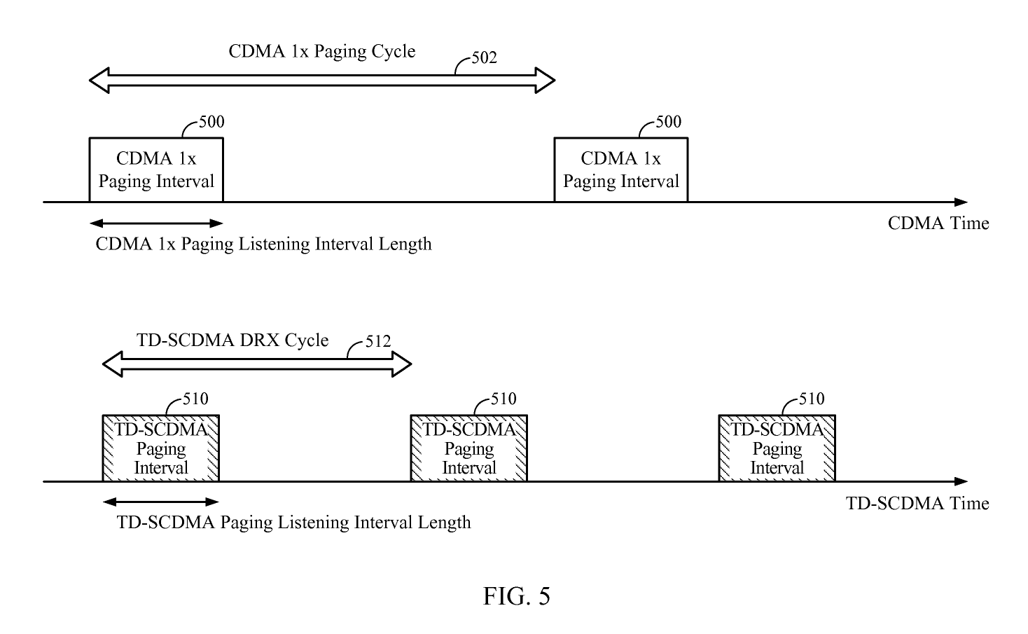

As an example, FIG. 5 illustrates a paging interval conflict between a paging interval 500 of a CDMA 1x network and a paging interval 510 of a TD-SCDMA network. The paging interval conflict illustrated occurs during the first CDMA 1x paging cycle 502 and the first TD-SCDMA discontinuous receive (DRX) cycle 512 depicted.

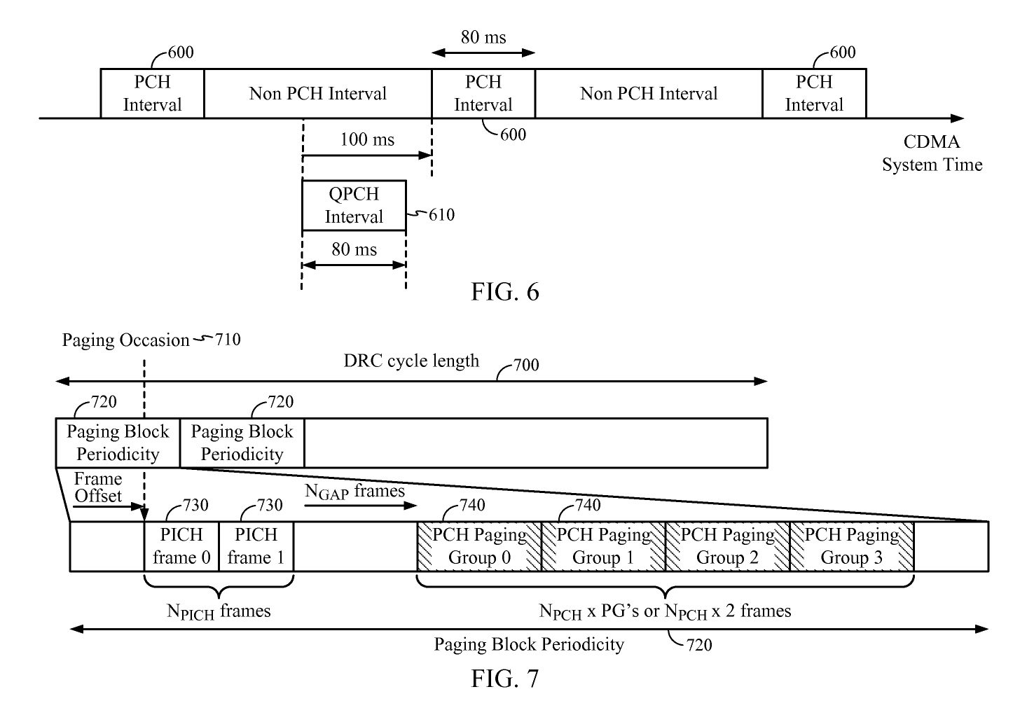

In CDMA 1x, an MS in idle slotted mode will listen to certain recurrent paging intervals. FIG. 6 illustrates the operation of the CDMA 1x paging cycle. Within a paging cycle, the paging interval may comprise an 80 ms PCH (Paging Channel) interval 600 preceded by a QPCH (Quick Paging Channel) interval 610 by 100 ms. Therefore, the MS may monitor paging messages for a 180 ms time interval per paging cycle. The MS may most likely start to monitor at system time t-5 where t is the CDMA system time to monitor PCH if needed, in units of 20 ms frame, calculated by:

t mod [16*(2^{SLOT}^{_{—}}^{CYCLE}^{_{—}}^{INDEX}))=4*PGSLOT (1)

The above parameter SLOT_CYCLE_INDEX=0, 1, . . . , 7 can determine the length of a CDMA 1x paging cycle interval, namely 1.28 sec*2^{SLOT}^{_{—}}^{CYCLE}^{_{—}}^{INDEX}. SLOT_CYCLE_INDEX is typically provisioned at the MS, but a BS may limit the maximum value by broadcasting the maximum of SLOT_CYCLE_INDEX in the System Parameter Message.

Each MS may have different time offset PGSLOT to listen to a CDMA paging message. PGSLOT is a hashed function of the MS's IMSI (International Mobile Subscriber Identifier).

FIG. 7 illustrates a Discontinuous Reception (DRX) cycle 700 for TD-SCDMA with the Paging Block Periodicity (PBP) 720 and the structure of a TD-SCDMA Paging Indicator Channel (PICH) 730 and a Paging Channel (PCH) 740. In TD-SCDMA, the UE in idle mode DRX operation may listen to certain recurrent paging blocks with a PICH 730. The DRX cycle 700 may be determined by circuit-switched (CS) CN (Core Network) in the System Information message. In addition, the DRX cycle 700 may be negotiated between the packet-switched (PS) CN with the UE in the General Packet Radio Service (GPRS) attach procedure. In the GPRS attach procedure, the UE may request the DRX cycle length in 2^{k} frames, where k=3, 4, 5, 6, 7, 8, 9. The final DRX cycle length is the minimum between CS CN and PS CN. That is,

DRX_cycle_length=min {DRX_cycle_length_{—}CS, DRX_cycle_length_{—}PSI (2)

Each UE may then listen to the PICH 730 starting with the associated paging occasion 710, given by the following formula:

paging_occasion=(IMSI div K)mod(DRX_cycle_length div PBP)*PBP+frame_offset+i*DRX_cycle_length (3)

where the PBP (Paging Block Periodicity) is the number of frames between two paging blocks and frame_offset is the frame offset of the first frame in the PBP, provided by the System Information message. IMSI is the International Mobile System Identity and K is the number of S-CCPCHs (Secondary Common Control Physical Channels) that can carry PCH (Paging Channel).

Per Paging Block Periodicity, there is a PICH for _{NPICH} frames and PCH with N_{PCH}*2 frames. There are N_{GAP} frames from the end of the PICH to the beginning of the PCH. The UE may be assigned to one of the N_{PICH} frames in a PICH block and one of the N_{PCH} paging groups (each of 2 frames) in the PCH, which starts from the associated paging occasion 710. The parameters N_{PICH}, N_{GAP}, N_{PCH} may be known from System Information.

The UE may only need to listen to some specific frame of PICH according to the following formula:

n=[(IMSI div 8192)mod(N_{PICH}*N_{PI})] div N_{PI} (4)

where N_{PI} is the number of paging indicators per frame in the PICH and can be derived from System Information. Moreover, the UE may only need to listen to one specific paging group on PCH using the following formula:

m=((IMSI div 8192)mod(N_{PICH}*N_{PI}))mod N_{PCH} (5)

Therefore, from one perspective, the UE may select only one frame of the paging block per DRX cycle length to monitor PICH.

From a timing perspective, the CDMA 1x base transceiver station (BTS) is synchronous. The TD-SCDMA frame boundary is synchronous, but the system frame number (SFN) may be asynchronous for different Node Bs (NBs). However, when the multimode terminal registers with both a CDMA 1x network and a TD-SCDMA network for listening to paging messages, there may be some time during which the CDMA 1x QPCH monitoring interval and the TD-SCDMA PICH monitoring frame conflict.

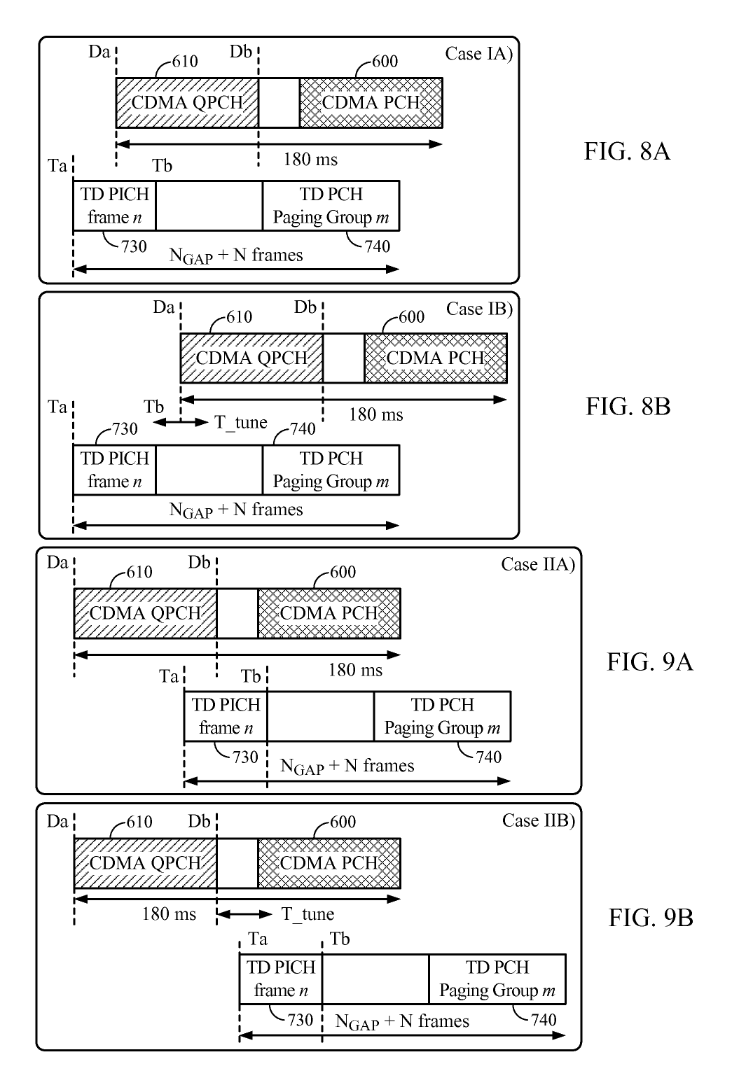

FIGS. 8A and 8B illustrate this conflict when the 80 ms QPCH interval trails the PICH frame. Therefore, the time relationship for this instance may be expressed as:

Ta≦Da<Tb+T_tune (6a)

FIGS. 9A and 9B illustrate this conflict when the QPCH interval leads the PICH frame. Therefore, the time relationship for this instance may be expressed as:

Da≦Ta<Db+T_tune (6b)

where the above variables Ta and Tb are the beginning and end time, respectively, of a corresponding monitored PICH frame in TD-SCDMA. Da and Db are the beginning and end time, respectively, of a corresponding QPCH monitored interval in CDMA. T_tune is the delay for the MMT to tune from one RAT to another RAT, acquire the channel, and be ready to decode the QPCH/PICH information.

Accordingly, what is needed are techniques and apparatus for reducing conflicts in the above QPCH/PICH monitoring. Certain aspects of the present disclosure provide methods for an MMT, such as a TD-SCDMA multimode UE, to register with CDMA 1x RTT and TD-SCDMA networks and monitor paging messages in idle mode while reducing the QPCH/PICH monitoring conflicts.

However in the TD-SCDMA network, the SFN are asynchronous and, therefore, it is very difficult to schedule the PICH monitoring interval to avoid conflicts completely. Fortunately, one feature of the paging procedure involves the network retrying should the network not receive a paging response. Therefore, aspects of the present disclosure attempt to avoid consecutive QPCH/PICH conflicts. To achieve this, the UE may use the GPRS attach procedure to adjust the PS DRX cycle length.

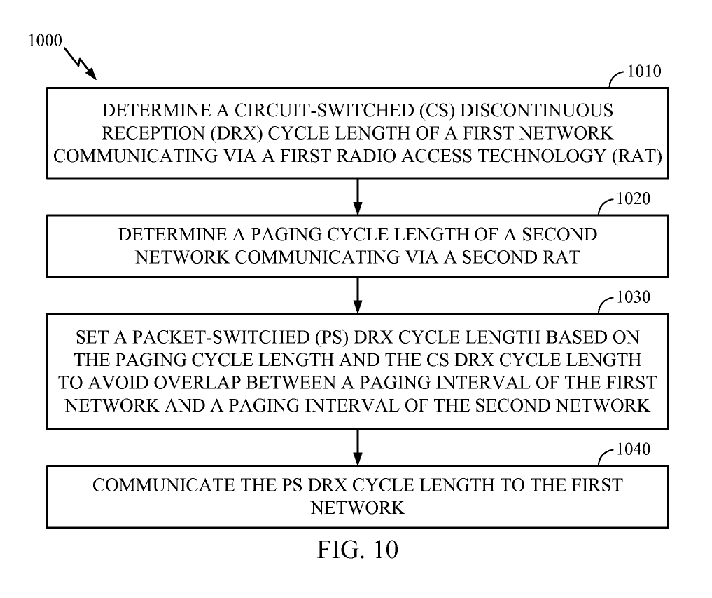

FIG. 10 is a functional block diagram conceptually illustrating example blocks 1000 executed to schedule paging intervals for an MMT in an effort to reduce paging interval conflicts between paging intervals of two networks communicating via two different RATs. Operations illustrated by the blocks 1000 may be executed, for example, at the processor(s) 370 and/or 390 of the UE 350 from FIG. 3. The operations may begin at block 1010 by determining a circuit-switched (CS) DRX cycle length of a first network communicating via a first RAT. The MMT may determine a paging cycle length of a second network communicating via a second RAT at block 1020. At block 1030, the MMT may set a PS DRX cycle length based on the paging cycle length and the CS DRX cycle length to avoid overlap between a paging interval of the first network and a paging interval of the second network (or at least to reduce conflicts between paging intervals of the first network and paging intervals of the second network). The MMT may communicate the PS DRX cycle length to the first network at block 1040.

There are two cases considered in this disclosure: (1) when the CS DRX cycle length is greater than or equal to the CDMA 1x paging cycle (i.e., 1.28* 2^{SLOT}^{_{—}}^{CYCLE}^{_{—}}^{INDEX} sec) and (2) when the CS DRX cycle length is less than the CDMA 1x paging cycle.

Case 1): DRX_cycle_length≧1x_paging_cycle

Denote 2^{L}=DRX_cycle_length_{—}CS/1x_paging_cycle (7)

The MMT may choose one DRX cycle length PS value:

DRX_cycle_length_{—}PS=DRX_cycle_length_{—}CS/2^{j}, such that DRX_cycle_length_{—}PS=0.01*2³, 0.01*2⁴, . . . , 0.01*2⁹sec and j≠L (8)

Case 2): DRX_cycle_length_CS≦1x_paging_cycle

The MMT may choose one DRX_cycle_length_PS value allowed by the standards:

DRX_cycle_length_{—}PS=0.01*2³, 0.01*2⁴, . . . , 0.01*2⁹sec (9)

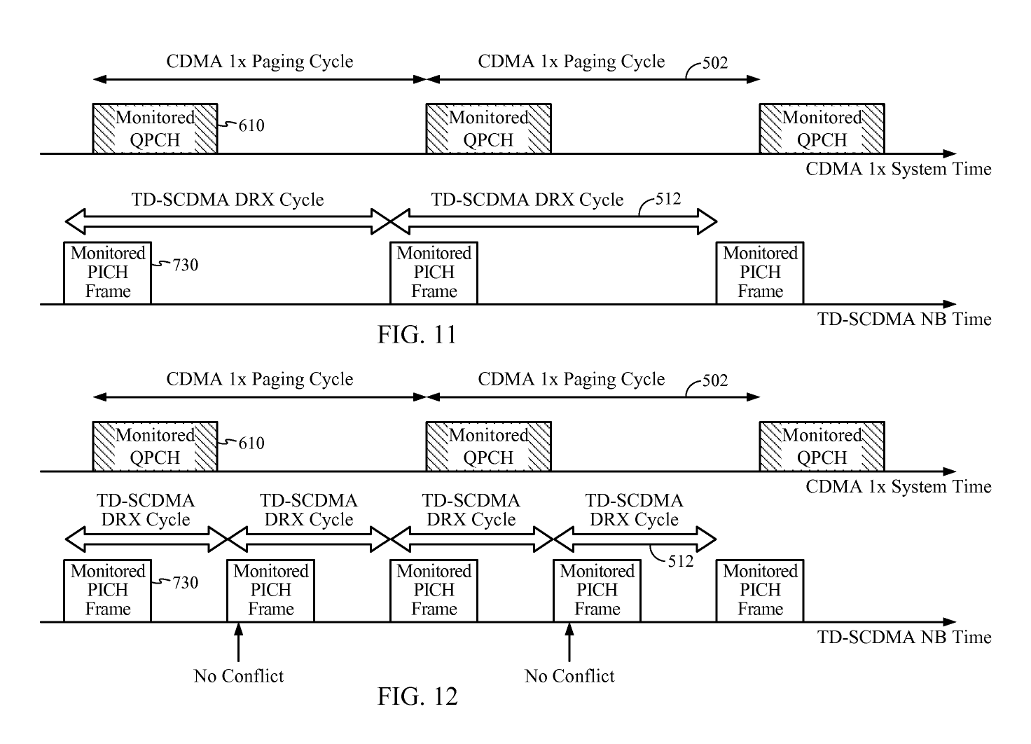

The goal is to avoid consecutive paging conflicts. Otherwise, if there is one conflict, the next PICH monitoring interval will always conflict. For example, FIG. 11 illustrates the undesired case of the TD-SCDMA DRX cycle length equaling the CDMA 1x paging cycle, such that QPCH interval 610 and the PICH frame 730 always conflict.

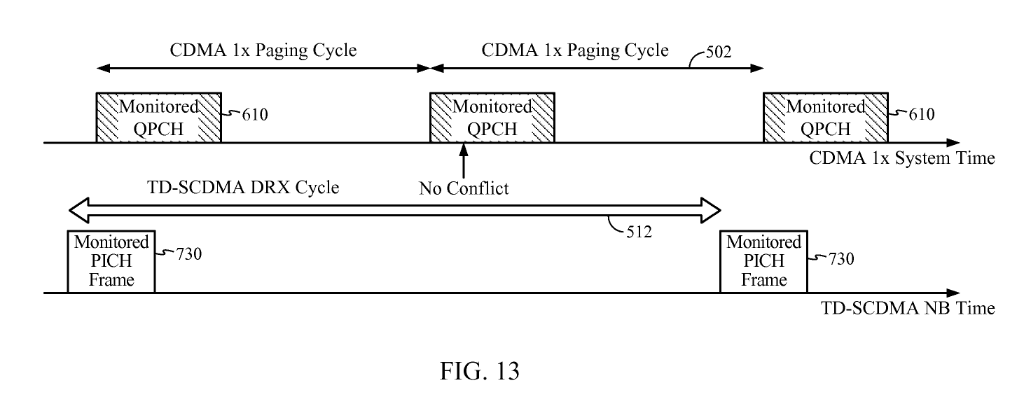

As one example of the desired behavior when DRX_cycle_length≠1x_paging_cycle, FIG. 12 illustrates the case where if there is a paging interval conflict, the next TD-SCDMA PICH frame 730 does not conflict with the CDMA 1x QPCH interval 610 by choosing a smaller TD-SCDMA DRX cycle length, in accordance with certain aspects of the present disclosure. As another example, FIG. 13 illustrates the case where if there is a paging interval conflict, the next CDMA 1x QPCH interval 610 does not conflict with the TD-SCDMA PICH frame 730 by choosing a larger TD-SCDMA DRX cycle length, in accordance with certain aspects of the present disclosure.

Aspects of the present disclosure also include conflict resolution algorithms. For some aspects, if there is any conflict, the RAT with the longer paging or DRX cycle may always be monitored. For other aspects, if there is any conflict, the RAT with the longer paging or DRX cycle is monitored probabilistically with larger than 0.5 probability (i.e., generate a random number R in the [0,1] interval). If R<p, then monitor the longer paging or DRX cycle RAT, where 0.5<p<1. For example, in FIG. 12 where CDMA 1x has a longer paging cycle, around the first TD PICH monitored frame, the MMT may tune to the CDMA 1x network to monitor QPCH. Then in the next TD-SCDMA PICH monitored frame, the MMT may tune to the TD-SCDMA network to monitor. As another example for FIG. 13 where TD-SCDMA has a longer DRX cycle, around the first CDMA 1x QPCH monitored interval, the MMT may tune to the TD-SCDMA network to monitor. Then in the next CDMA 1x QPCH monitored frame, the MMT may tune to the CDMA 1x network to monitor.

Note that the above figures show the operation when there is a conflict in QPCH and PICH monitoring. However, there should be no conflict in most cases. The conflict condition is determined by equations (6a) and (6b).

For some aspects, in order to reduce the chance of conflicts, the DRX_cycle_length_PS can be selected to make the ratio between 1x_paging_cycle and DRX_cycle_length large. Therefore, more non-conflicting QPCH/PICH can be monitored between two conflicts. However, the disadvantage is more power consumption. Therefore, if there is no conflict at one NB, then any DRX_cycle_length value can be used. Whenever there is conflict with a new NB, the proposed algorithm to choose the DRX_cycle_length_PS may be used, and the MMT may perform a GPRS re-attach procedure to update the DRX_cycle_length. Once the MMT moves to another NB without conflict, the normal DRX_cycle_length may once again be used by performing another GPRS reattach or routing area update procedure.

Aspects of the present disclosure may allow multimode terminals that can operate in idle mode with both CDMA 1xRTT and TD-SCDMA networks to monitor paging messages with a hybrid configuration. This can reduce consecutive conflicts and allow the network to succeed in paging.

In one configuration, the apparatus 350 for wireless communication includes means for determining a CS DRX cycle length of a first network communicating via a first RAT, means for determining a paging cycle length of a second network communicating via a second RAT, means for setting a PS DRX cycle length based on the paging cycle length and the CS DRX cycle length to avoid overlap between a paging interval of the first network and a paging interval of the second network, and means for communicating the PS DRX cycle length to the first network. In one aspect, the aforementioned means may be the processor(s) 370 and/or 390 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read-only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for communicating, by a multi-mode terminal (MMT), with first and second networks via first and second radio access technologies (RATs), comprising:
determining a circuit-switched (CS) discontinuous reception (DRX) cycle length of the first network;
determining a paging cycle length of the second network;
setting a packet-switched (PS) DRX cycle length based on the paging cycle length and the CS DRX cycle length to avoid overlap between a paging interval of the first network and a paging interval of the second network; and
communicating the PS DRX cycle length to the first network.

2. The method of claim 1, wherein the first RAT comprises Time Division Synchronous Code Division Multiple Access (TD-SCDMA).

3. The method of claim 2, wherein the second RAT comprises Code Division Multiple Access (CDMA) 1xRTT (Radio Transmission Technology).

4. The method of claim 3, wherein setting the PS DRX cycle length avoids overlap between a TD-SCDMA Paging Indicator Channel (PICH) interval and a CDMA 1xRTT Quick Paging Channel (QPCH) interval.

5. The method of claim 1, wherein setting the PS DRX cycle length comprises setting the PS DRX cycle length to avoid overlap between consecutive paging intervals of the first network and the paging interval of the second network.

6. The method of claim 1, wherein the CS DRX cycle length is less than the paging cycle length and wherein setting the PS DRX cycle length comprises setting the PS DRX cycle length equal to 0.01*2^{j} seconds, wherein 3≦j≦9.

7. The method of claim 1, wherein the CS DRX cycle length is greater than or equal to the paging cycle length and wherein setting the PS DRX cycle length comprises:
dividing the CS DRX cycle length by the paging cycle length to obtain a quotient; and
setting the PS DRX cycle length equal to the CS DRX cycle length divided by 2^{j}, wherein j cannot be equal to the binary logarithm of the quotient and 3≦j≦9, such that the PS DRX cycle length is equal to 0.01*2^{j} seconds.

8. The method of claim 1, wherein communicating the PS DRX cycle length to the first network comprises using a General Packet Radio Service (GPRS) attach or routing area update procedure.

9. An apparatus for communicating with first and second networks via first and second radio access technologies (RATs), comprising:
means for determining a circuit-switched (CS) discontinuous reception (DRX) cycle length of the first network;
means for determining a paging cycle length of the second network;
means for setting a packet-switched (PS) DRX cycle length based on the paging cycle length and the CS DRX cycle length to avoid overlap between a paging interval of the first network and a paging interval of the second network; and
means for communicating the PS DRX cycle length to the first network.

10. The apparatus of claim 9, wherein the first RAT comprises Time Division Synchronous Code Division Multiple Access (TD-SCDMA).

11. The apparatus of claim 10, wherein the second RAT comprises Code Division Multiple Access (CDMA) 1xRTT (Radio Transmission Technology).

12. The apparatus of claim 11, wherein the means for setting the PS DRX cycle length avoids overlap between a TD-SCDMA Paging Indicator Channel (PICH) interval and a CDMA 1xRTT Quick Paging Channel (QPCH) interval.

13. The apparatus of claim 9, wherein the means for setting the PS DRX cycle length comprises means for setting the PS DRX cycle length to avoid overlap between consecutive paging intervals of the first network and the paging interval of the second network.

14. The apparatus of claim 9, wherein the CS DRX cycle length is less than the paging cycle length and wherein the means for setting the PS DRX cycle length comprises means for setting the PS DRX cycle length equal to 0.01*2^{j} seconds, wherein 3≦j≦9.

15. The apparatus of claim 9, wherein the CS DRX cycle length is greater than or equal to the paging cycle length and wherein the means for setting the PS DRX cycle length comprises:
means for dividing the CS DRX cycle length by the paging cycle length to obtain a quotient; and
means for setting the PS DRX cycle length equal to the CS DRX cycle length divided by 2^{j}, wherein j cannot be equal to the binary logarithm of the quotient and 3≦j≦9, such that the PS DRX cycle length is equal to 0.01*2^{j} seconds.

16. The apparatus of claim 9, wherein the means for communicating the PS DRX cycle length to the first network comprises means for using a General Packet Radio Service (GPRS) attach or routing area update procedure.

17. An apparatus for communicating with first and second networks via first and second radio access technologies (RATs), comprising:
at least one processor configured to:
determine a circuit-switched (CS) discontinuous reception (DRX) cycle length of the first network;
determine a paging cycle length of the second network;
set a packet-switched (PS) DRX cycle length based on the paging cycle length and the CS DRX cycle length to avoid overlap between a paging interval of the first network and a paging interval of the second network; and
communicate the PS DRX cycle length to the first network; and
a memory coupled to the at least one processor.

18. The apparatus of claim 17, wherein the first RAT comprises Time Division Synchronous Code Division Multiple Access (TD-SCDMA).

19. The apparatus of claim 18, wherein the second RAT comprises Code Division Multiple Access (CDMA) 1xRTT (Radio Transmission Technology).

20. The apparatus of claim 19, wherein the at least one processor is configured to set the PS DRX cycle length to avoid overlap between a TD-SCDMA Paging Indicator Channel (PICH) interval and a CDMA 1xRTT Quick Paging Channel (QPCH) interval.

21. The apparatus of claim 17, wherein the at least one processor is configured to set the PS DRX cycle length to avoid overlap between consecutive paging intervals of the first network and the paging interval of the second network.

22. The apparatus of claim 17, wherein the CS DRX cycle length is less than the paging cycle length and wherein the at least one processor is configured to set the PS DRX cycle length by setting the PS DRX cycle length equal to 0.01*2^{j} seconds, wherein 3≦j≦9.

23. The apparatus of claim 17, wherein the CS DRX cycle length is greater than or equal to the paging cycle length and wherein the at least one processor is configured to set the PS DRX cycle length by:
dividing the CS DRX cycle length by the paging cycle length to obtain a quotient; and
setting the PS DRX cycle length equal to the CS DRX cycle length divided by 2^{j}, wherein j cannot be equal to the binary logarithm of the quotient and 3≦j≦9, such that the PS DRX cycle length is equal to 0.01*2^{j} seconds.

24. The apparatus of claim 17, wherein the at least one processor is configured to communicate the PS DRX cycle length to the first network by using a General Packet Radio Service (GPRS) attach or routing area update procedure.

25. A computer-program product for communicating with first and second networks via first and second radio access technologies (RATs), the computer-program product comprising:
a computer-readable medium having code for:
determining a circuit-switched (CS) discontinuous reception (DRX) cycle length of the first network;
determining a paging cycle length of the second network;
setting a packet-switched (PS) DRX cycle length based on the paging cycle length and the CS DRX cycle length to avoid overlap between a paging interval of the first network and a paging interval of the second network; and
communicating the PS DRX cycle length to the first network.

26. The computer-program product of claim 25, wherein the first RAT comprises Time Division Synchronous Code Division Multiple Access (TD-SCDMA).

27. The computer-program product of claim 26, wherein the second RAT comprises Code Division Multiple Access (CDMA) 1xRTT (Radio Transmission Technology).

28. The computer-program product of claim 27, wherein setting the PS DRX cycle length avoids overlap between a TD-SCDMA Paging Indicator Channel (PICH) interval and a CDMA 1xRTT Quick Paging Channel (QPCH) interval.

29. The computer-program product of claim 25, wherein setting the PS DRX cycle length comprises setting the PS DRX cycle length to avoid overlap between consecutive paging intervals of the first network and the paging interval of the second network.

30. The computer-program product of claim 25, wherein the CS DRX cycle length is less than the paging cycle length and wherein setting the PS DRX cycle length comprises setting the PS DRX cycle length equal to 0.01*2^{j} seconds, wherein 3≦j≦9.

31. The computer-program product of claim 25, wherein the CS DRX cycle length is greater than or equal to the paging cycle length and wherein setting the PS DRX cycle length comprises:
dividing the CS DRX cycle length by the paging cycle length to obtain a quotient; and
instructions for setting the PS DRX cycle length equal to the CS DRX cycle length divided by 2^{j}, wherein j cannot be equal to the binary logarithm of the quotient and 3≦j≦9, such that the PS DRX cycle length is equal to 0.01*2^{j} seconds.

32. The computer-program product of claim 25, wherein communicating the PS DRX cycle length to the first network comprises using a General Packet Radio Service (GPRS) attach or routing area update procedure.
